(19) United States
(12) Patent Application Publication
(10) Pub. No.: US 2011/0140054 A1
(43) Pub. Date: Jun. 16, 2011

(54) COMPOSITION FOR PREPARING BUS ELECTRODE AND PLASMA DISPLAY PANEL INCLUDING ELECTRODE PREPARED THEREFROM

(76) Inventors: Jae Joon SHIM, Uiwang-si (KR); Jae Hwi Cho, Uiwang-si (KR); Yong Hyun Kim, Uiwang-si (KR); Hyun Don Kim, Uiwang-si (KR)

(21) Appl. No.: 12/961,125

(22) Filed: Dec. 6, 2010

(30) Foreign Application Priority Data
Dec. 11, 2009 (KR) 10-2009-0123080

(51) Int. Cl. H01B 1/22

(52) U.S. Cl. 252/513

(57) ABSTRACT

An example embodiment is directed to a composition for preparation of an electrode, including: a conductive material, the conductive material including Ni, Ag, and ITO, an organic binder, a glass fit, and a black pigment.

### BACKGROUND

1. Field

Embodiments relate to a composition for preparing a bus electrode and a plasma display panel including an electrode prepared therefrom.

2. Description of the Related Art

In general, a plasma display panel (PDP) refers to a device for displaying an image by exciting phosphors with UV rays obtained through gas discharge. The PDP has been a focus of attention as a next generation thin display due to its large screen size and high resolution.

In a general PDP, address electrodes are formed in one direction on a rear substrate and a dielectric layer is formed over the rear substrate to cover the address electrodes. On the dielectric layer, barriers are formed in a stripe pattern between the address electrodes and phosphor layers of red (R), green (G) and blue (B) are formed between the respective barriers. On one side of a front substrate facing the rear substrate, a pair of display electrodes composed of a transparent electrode and a bus electrode is formed in a direction crossing the address electrodes. The display electrodes are covered with a dielectric layer and an MgO protective layer that are formed over the front substrate. Discharge cells are formed at points where the address electrodes on the rear substrate cross the display electrodes on the front substrate. In order to operate the discharge cells of the plasma display panel, an address voltage Va is applied between the address electrode and the display electrode to perform address discharge and a sustain voltage Vs is applied between the pair of discharge electrodes to perform sustain discharge. Here, excitation light is emitted to excite the phosphors to emit visible light through the transparent front substrate, thereby realizing a PDP screen.

### SUMMARY

An example embodiment is directed to a composition for preparation of an electrode, including: a conductive material, the conductive material including Ni, Ag, and ITO, an organic binder, a glass fit, and a black pigment.

The conductive material may be contained in an amount of about 0.5 to about 10 wt % in the composition.

The conductive material may have a weight ratio of Ni:Ag:ITO of about 1:0.1 to 3:0.5 to 2.

The composition may include about 0.5 to about 10 wt % of the conductive material, about 1 to about 30 wt % of the organic binder, about 5 to about 40 wt % of the glass fit, and about 5 to about 20 wt % of the black pigment.

The organic binder may include one or more of an acrylic resin, a styrene resin, a novolac resin, a polyester resin, a water-soluble cellulose resin, a polyvinyl alcohol resin, an epoxy resin, a melamine resin, and a polyvinyl butyral resin.

The glass frit may include one or more of zinc oxide-silicon oxide (ZnO—SiO₂) glass frit, zinc oxide-boron oxide-silicon oxide (ZnO—B₂O₃—SiO₂) glass fit, zinc oxide-boron oxide-silicon oxide-aluminum oxide (ZnO—B₂O₃—SiO₂—Al₂O₃) glass frit, bismuth oxide-silicon oxide (Bi₂O₃—SiO₂) glass frit, bismuth oxide-boron oxide-silicon oxide (Bi₂O₃—B₂O₃—SiO₂) glass frit, bismuth oxide-boron oxide-silicon oxide-aluminum oxide (Bi₂O₃—B₂O₃—SiO₂—Al₂O₃) glass frit, bismuth oxide-zinc oxide-boron oxide-silicon oxide (Bi₂O₃—ZnO—B₂O₃—SiO₂) glass frit, and bismuth oxide-zinc oxide-boron oxide-silicon oxide-aluminum oxide (Bi₂O₃—ZnO—B₂O₃—SiO₂—Al₂O₃) glass frit.

The black pigment may include a metal oxide containing at least one element selected from the group of Ru, Cr, Fe, Co, Mn, Cu, Ni.

The composition may further include at least one of a sensitizer, a polymerization inhibitor, an antioxidant, an UV-absorber, an antifoaming agent, a dispersing agent, a leveling agent, and a plasticizer.

Example embodiments are also directed to a plasma display panel including an electrode prepared from a composition according to an embodiment.

Example embodiments are also directed to a method of fabricating a plasma display panel, the method including forming an electrode shape using a composition that includes a conductive material, the conductive material including Ni, Ag, and ITO, an organic binder, a glass fit, and a black pigment; and sintering the electrode shape to form an electrode.

### DETAILED DESCRIPTION

Korean Patent Application No. 10-2009-0123080, filed on Dec. 11, 2009, in the Korean Intellectual Property Office, and entitled: “Composition for Preparing Bus electrode and Plasma Display Panel Comprising Electrode Prepared Therefrom,” is incorporated by reference herein in its entirety.

Example embodiments will now be described more fully hereinafter; however, they may be embodied in different forms and should not be construed as limited to the embodiments set forth herein. Rather, these embodiments are provided so that this disclosure will be thorough and complete, and will fully convey the scope of the invention to those skilled in the art.

It will be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. It will also be understood that when a layer is referred to as being “between” two layers, it can be the only layer between the two layers, or one or more intervening layers may also be present.

In accordance with an embodiment, a composition for preparation of an electrode for a plasma display panel (PDP) includes: (a) a conductive material including Ni, Ag, and indium tin oxide (ITO), (b) an organic binder, (c) a glass fit, and (d) a black pigment. In an implementation, the composition may include (e) a solvent.

Components of the composition according to an embodiment will now be described in detail.

Conductive Material

In accordance with an embodiment, the conductive material is a metallic material. In accordance with an embodiment, the conductive material consists essentially of Ni, Ag, and ITO. In accordance with an embodiment, the conductive material includes Ni, Ag, and ITO, and one or more metal powders such as silver (Ag), gold (Au), palladium (Pd), platinum (Pt), copper (Cu), chrome (Cr), cobalt (Co), aluminum (Al), tin (Sn), lead (Pb), zinc (Zn), iron (Fe), iridium (Ir), osmium (Os), rhodium (Rh), tungsten (W), and molybdenum (Mo).

The content of conductive material may be about 0.5 to about 10% by weight (wt %), and preferably about 1 to about 5 wt %, of the composition. If the content of conductive material is less than about 0.5 wt %, sufficiently low contact resistance may not be provided, which may increase the likelihood of discharge failure. If the content of conductive material exceeds about 10 wt %, the degree of blackness may be reduced, e.g., as a result of color change after sintering of the conductive material.

Further, in order to provide a maximum degree of blackness at a low contact resistance, the ratio (weight ratio) of Ni, Ag and ITO, respectively, may be about 1:0.1 to 3:0.5 to 2, and preferably about 1:0.4 to 2.3:0.6 to 1.5.

The conductive material may have, e.g., a granular shape, a spherical shape or a flake shape. Considering optical properties and dispersibility, the conductive material advantageously has a spherical shape, and may have a single shape or a combination of two or more different shapes. The conductive material may have an average particle diameter from about 0.01 to about 10 μm. If the conductive material has an average particle diameter less than about 0.01 μm, the light transmittance may become deteriorated, which may make it difficult to form a highly precise electrode pattern, e.g., when using a lithographic electrode pattern forming process. If the conductive material has an average particle diameter exceeding about 10 μm, the linearity of the electrode pattern may be reduced.

Organic Binder

The organic binder may include a polymer that provides a good binding force and can be easily removed by a baking or sintering process during the formation of the electrode.

For example, the organic binder may include one or more of an acrylic resin, a styrene resin, a novolac resin, a polyester resin, a water-soluble cellulose resin, a polyvinyl alcohol resin, an epoxy resin, a melamine resin, and a polyvinyl butyral resin.

Further, the organic binder may exhibit good viscosity when the composition for the preparation of the electrode is applied to a substrate to form a photosensitive conductive film, e.g., a lithographic film, and may have a weight average molecular weight of about 5,000 to about 50,000 g/mol and an acid value of about 20 to about 100 mg KOH/g for facilitating decomposition during baking.

The content of organic binder may be about 1 to about 30 wt %, and preferably about 5 to about 25 wt %, of the composition. If the content of organic binder is less than about 1 wt %, electrode pattern removal from the substrate may occur after exposure and development. If the content of organic binder exceeds about 30 wt %, increase in electrode resistance and reduction in degree of blackness, caused by a relative decrease in the amount of black pigment, may result.

Glass Frit

The composition may include a glass frit. The glass frit may enhance bonding force between the conductive material and the substrate during baking, and may be softened to agglomerate to the substrate layer during sintering.

The glass frit may include a leadless glass frit, e.g., a glass frit that is “lead free” to the extent specified by an industry standard restricting lead content, such a standard reflecting the EU RoHS Directive. The glass frit preferably includes one or more of zinc oxide-silicon oxide (ZnO—SiO₂) glass frit, zinc oxide-boron oxide-silicon oxide (ZnO—B₂O₃—SiO₂) glass fit, zinc oxide-boron oxide-silicon oxide-aluminum oxide (ZnO—B₂O₃—SiO₂—Al₂O₃) glass frit, bismuth oxide-silicon oxide (Bi₂O₃—SiO₂) glass frit, bismuth oxide-boron oxide-silicon oxide (Bi₂O₃—B₂O₃—SiO₂) glass fit, bismuth oxide-boron oxide-silicon oxide-aluminum oxide (Bi₂O₃—B₂O₃—SiO₂—Al₂O₃) glass frit, bismuth oxide-zinc oxide-boron oxide-silicon oxide (Bi₂O₃—ZnO—B₂O₃—SiO₂) glass fit, and bismuth oxide-zinc oxide-boron oxide-silicon oxide-aluminum oxide (Bi₂O₃—ZnO—B₂O₃—SiO₂—Al₂O₃) glass fit.

The glass frit may have, but is not limited to, an amorphous shape or a spherical shape, and may have an average particle diameter of about 0.1 to about 5 μm, which may help ensure a uniform surface after baking, and good linearity.

The content of glass frit may be about 5 to about 40 wt %, and preferably about 10 to about 30 wt %, of the composition. If the content of glass frit is less than about 5 wt %, an increase in edge curl or decrease in adhesion to the substrate after sintering may occur. If the content of glass frit exceeds about 40 wt %, a decreased degree of blackness or pattern blistering may occur.

Black Pigment

The black pigment may be provided to enhance screen contrast in the plasma display panel.

The black pigment may include one or more metal oxides. The metal oxide may include one or more elements selected from the group of Ru, Cr, Fe, Co, Mn, Cu, and Ni. For example, the black pigment may include cobalt oxide, CuCrMn oxide, or a mixture thereof. Considering leveling performance in printing, the black pigment may have a specific surface area of about 5 to about 20 m²/g. Further, the black pigment may have an average particle diameter of about 0.05 to about 5 μm. If the average particle diameter of the black pigment is less than about 0.05 μm, the dispersibility in the composition may be reduced due to agglomeration of the pigment particles. If the average particle diameter of the black pigment exceeds about 5 μm, it may be difficult to obtain a desired degree of blackness.

The content of black pigment may be about 5 to about 20 wt %, and preferably about 10 to about 15 wt %, of the composition. If the content of black pigment is less than about 5 wt %, the degree of blackness may be reduced. If the content of black pigment exceeds about 20 wt %, decreased adhesion to the substrate or increased edge curl after baking may occur.

Solvent

The solvent may have a boiling point of about 120° C. or more. Example solvents include methyl cellosolve, ethyl cellosolve, butyl cellosolve, aliphatic alcohol, α-terpineol, β-terpineol, dihydro-terpineol, ethylene glycol, ethylene glycol mono butyl ether, butyl cellosolve acetate, and texanol. These solvents may be used alone or in a combination of two or more thereof.

In the composition, the solvent may be contained in the balance amount that is obtained by subtracting the sum of other components from 100 wt % of the composition. In general, the content of solvent may be about 1 to about 60 wt %, and may be varied depending on applications of the composition. Adjustment of viscosity may be facilitated by adjusting the added amount of solvent.

In the composition, the solvent may be present as a solvent of the binder (b) to be mixed with other components to constitute the composition.

Other Additives

In addition to the components described above, the composition may further include various additives. Examples of the additives include sensitizers for enhancing sensitivity; polymerization inhibitors for improving sustainability of coating compositions, such as phosphoric acid, phosphoric ester, carboxylic acid-containing compounds, and the like; antioxidants; UV-absorbers for improving resolution; antifoaming agents for reducing bubbles in a paste, such as silicone or acrylic compounds; dispersing agents for improving dispersibility; a leveling agent for improving film flatness in printing, such as polyester modified dimethylpolysiloxane, polyhydroxycarboxylic amide, silicone-based polyacrylate copolymers or fluorine-based paraffin compounds; plasticizers for imparting thixotropy, etc. The leveling agent may be added in an amount of about 0.1 to about 2 parts by weight based on 100 parts by weight of the composition.

The composition for preparation of a black electrode (black layer) described above may be prepared by, e.g., mixing the conductive material, the black pigment, the organic binder, the glass frit, and the solvent. A photosensitive conductive film for formation of the black layer may be formed by applying the composition to a substrate, which may have a transparent electrode formed thereon, and drying the same. A photosensitive conductive film for formation of a white layer may be formed by applying and drying a composition for preparation of the white layer to cover the conductive film. An electrode pattern may be formed through exposure, development and baking, producing a bus electrode that has, e.g., a double-layer structure of the black layer and the white layer on a transparent electrode.

The following Examples and Comparative Examples are provided in order to set forth particular details of one or more embodiments. However, it will be understood that the embodiments are not limited to the particular details described. Further, the Comparative Examples are set forth to highlight certain characteristics of certain embodiments, and are not to be construed as either limiting the scope of the invention as exemplified in the Examples or as necessarily being outside the scope of the invention in every respect.

Table 1 shows raw materials used for examples and comparative examples.

TABLE 1

| | Description | Manufacturer/Grade |
|---|---|---|
| Acryl binder | Acryl binder: POLY(METHYL | Cheil Industries |
| solution (solid | METHACRYLATE-CO- | Inc./OV5300 |
| content 30%) | METHACRYLIC ACID) | |
| | solvent: texanol | |
| Black pigment | Cobalt Oxide | Ise Chemical Industry |
| | | Co./B5300 |
| Leveling agent | Silicon-based leveling agent | BYK 053 |
| Glass frit | Bi-based glass powder, | Particlogy/BF101 |
| | average diameter 0.8 μm | |
| Ag powder | Average diameter 1.3 μm | Dowa/3-7F |
| Ni powder | Average diameter 1.0 μm | Ni101 |
| ITO powder | Average diameter 50 nm | ANP/ITO10T |

### Preparation of Paste Composition for Black Electrode (Black Layer)

### Examples 1 to 4

A glass powder, Ag powder, Ni powder, ITO powder, and acryl binder solution were mixed in a composition ratio as listed in Table 2, and the mixture was dispersed by taking 5 passes using a ceramic 3-roll mill, thereby preparing a glass paste. Then, a black pigment and a leveling agent were mixed with the glass paste in a composition ratio as listed in Table 2, and the mixture was dispersed by taking 3 passes using a ceramic 3-roll mill, thereby preparing a paste for preparation of a black electrode.

TABLE 2
(unit: wt %)

| | | | | | Comparative | Comparative |
|---|---|---|---|---|---|---|
| | Example 1 | Example 2 | Example 3 | Example 4 | Example 1 | Example 2 |
| Acryl binder | 59.5 | 58.7 | 58.7 | 58.9 | 59.5 | 59.5 |
| solution | | | | | | |
| Black pigment | 10.6 | 10.6 | 10.6 | 10.6 | 10.6 | 10.6 |
| Leveling agent | 0.4 | 0.4 | 0.4 | 0.4 | 0.4 | 0.4 |
| Glass frit | 27.1 | 27.1 | 27.1 | 27.1 | 27.1 | 27.1 |
| Ag powder | 0.7 | 1.5 | 0.7 | 1.0 | 1.2 | — |
| Ni powder | 0.7 | 0.7 | 1.5 | 1.0 | 1.2 | — |
| ITO powder | 1.0 | 1.0 | 1.0 | 1.0 | — | 2.4 |
| Total | 100 | 100 | 100 | 100 | 100 | 100 |

### Comparative Examples 1 and 2

A composition for preparation of a black electrode was prepared as in Examples, except for the variation of the composition ratio of raw materials including the conductive powder as shown in Table 2.

Experiment

Evaluation of Contact Resistance

1) The paste prepared as above was printed in a size of 7×7 cm on a glass substrate, on which ITO was deposited, using an SUS 325 mesh, followed by drying at 110° C. for 20 minutes.

2) SS5300A Ag paste (Cheil Industries Inc.) was printed in a size of 5×5 cm at the center of the glass substrate, on which the paste for preparation of the black layer was deposited, using an SUS 325 mesh, followed by drying at 110° C. for 20 minutes.

3) The substrate thus prepared was baked three times at 580° C., followed by measurement of current conducting properties of the ITO layer and the Ag layer using a resistance meter with a probe width of about 5 cm. The results are shown in Table 3.

Evaluation of Blackness and Yellowness

1) The paste prepared as above was printed in a size of 7×7 cm on a glass substrate using a Poly 350 mesh, followed by drying at 110° C. for 20 minutes.

2) After baking the dried substrate once at 580° C., the blackness and the yellowness viewed from the back of the glass substrate were measured using a colorimeter (Minol 508i). The results are shown in Table 3.

In the L*a*b color order system, the L* channel represents a level of brightness, in which the lower the L* value, the higher the degree of blackness. Further, the b* channel represents a relationship between blue and yellow, in which a negative number implies a blue color and a positive number implies a yellow color.

Evaluation of Edge Curl

1) The paste prepared as above was printed in a size of 7×7 cm on a glass substrate, on which ITO was deposited, using n SUS 325 mesh, followed by drying at 110° C. for 20 minutes. Then, SS5300A Ag paste (Cheil Industries Inc.) was printed in a size of 5×5 cm at the center of the glass substrate, on which the paste for preparation of the black layer was deposited, followed by drying at 110° C. for 20 minutes.

2) The dried sample was subjected to exposure using a UV illuminator of 300 mJ and a mask of 70 μm, followed by development using a development solution prepared to have a concentration of 0.3% sodium carbonate to form an electrode pattern of 70 μm.

3) The electrode pattern thus prepared was baked at 580° C., followed by measurement of the edge curl using a profiler (Tencor P10). The results are shown in Table 3.

TABLE 3

| | | | | | Comparative | Comparative |
|---|---|---|---|---|---|---|
| | Example 1 | Example 2 | Example 3 | Example 4 | Example 1 | Example 2 |
| Contact resistance | 150 | 100 | 120 | 100 | 2000 | 1700 |
| (Ω) | | | | | | |
| Blackness L* | 29 | 34 | 29 | 31 | 34 | 29 |
| Yellowness b | −1.7 | 1.2 | −1.2 | 1.5 | 1.2 | −1.8 |
| Edge curl (μm) | 0.5 | 0.5 | 0.5 | 0.5 | 4.0 | 0.5 |

In evaluation of a composition and an electrode produced using the same, when the composition and the electrode have a contact resistance of 200Ω or less, a degree of blackness of 40 or less, a degree of yellowness of 1.5 or less, and an edge curl of 1 μM or less, they may be evaluated as good.

According to these standards, Examples 1 to 3, which contained the conductive material having Ni, Ag, and ITO, demonstrated considerably improved (lowered) resistance as compared with Comparative Example 1, which had Ag and Ni as the conductive material, and Comparative Example 2, which had ITO as the conductive material. Further, in evaluation of the blackness, yellowness and edge curl, Examples 1 to 3 satisfy all of the aforementioned standards by exhibiting an insignificant increase in post-baking yellowness, a high degree of blackness and stable discharge characteristics. Therefore, it can be confirmed that a composition according to an embodiment may be useful in the related art.

As described above, embodiments relate to a composition for preparation of an electrode of a plasma display panel (PDP). A PDP bus electrode may have a double-layer structure of a black electrode (black layer) and an Ag electrode (white layer) on a glass substrate on which ITO is deposited. For PDP discharge, current conducting properties of the Ag electrode and the ITO electrode should be provided. A black electrode containing ruthenium oxide with a high degree of blackness and high conductivity requires the use of expensive ruthenium, which may lead to an increase in material cost in fabrication of the PDP. A black electrode providing blackness and good contact resistance, having metal such as Ag, Ni, or Au, e.g., an Ag—Pd alloy (E. I. du Pont de Nemours and Company), Ag (Noritake), and Ni (Taiyo Ink Mfg. Co., Ltd.) may be used. However, the Ag—Pd alloy, like ruthenium, is expensive, and Ag may not provide sufficient contact resistance and while increasing of yellowness, which deteriorates the quality of the panel. Further, the use of Ni may lower sintering properties of the bus electrode, generate high edge curl, and causing discharge failure. In contrast, a feature of an embodiment is to provide a technique capable of forming an electrode that has price competitiveness and may maintain a sufficient degree of blackness and contact resistance in fabrication of a PDP. An example embodiment of the composition for preparation of a PDP electrode contains, as a conductive material, a mixture of Ag, Ni, and indium tin oxide (ITO). The composition may exhibit a lower degree of post-baking yellowness and a high degree of blackness in an electrode of a PDP, while providing low ITO contact resistance and stable discharge characteristics. The composition may be a material for forming a black layer of the PDP electrode and may be prepared using a mixture of Ni, Ag and ITO.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope of the present invention as set forth in the following claims.

What is claimed is:

1. A composition for preparation of an electrode, comprising:
a conductive material, the conductive material including Ni, Ag, and ITO;
an organic binder;
a glass frit; and
a black pigment.

2. The composition as claimed in claim 1, wherein the conductive material is about 0.5 to about 10 wt % of the composition.

3. The composition as claimed in claim 1, wherein the conductive material has a weight ratio of Ni:Ag:ITO of about 1:0.1 to 3:0.5 to 2.

4. The composition as claimed in claim 1, wherein the composition includes:
about 0.5 to about 10 wt % of the conductive material,
about 1 to about 30 wt % of the organic binder,
about 5 to about 40 wt % of the glass frit, and
about 5 to about 20 wt % of the black pigment.

5. The composition as claimed in claim 1, wherein the organic binder includes one or more of an acrylic resin, a styrene resin, a novolac resin, a polyester resin, a water-soluble cellulose resin, a polyvinyl alcohol resin, an epoxy resin, a melamine resin, and a polyvinyl butyral resin.

6. The composition as claimed in claim 1, wherein the glass frit includes one or more of zinc oxide-silicon oxide (ZnO—SiO₂) glass fit, zinc oxide-boron oxide-silicon oxide (ZnO—B₂O₃—SiO₂) glass frit, zinc oxide-boron oxide-silicon oxide-aluminum oxide (ZnO—B₂O₃—SiO₂—Al₂O₃) glass fit, bismuth oxide-silicon oxide (Bi₂O₃—SiO₂) glass frit, bismuth oxide-boron oxide-silicon oxide (Bi₂O₃—B₂O₃—SiO₂) glass frit, bismuth oxide-boron oxide-silicon oxide-aluminum oxide (Bi₂O₃—B₂O₃—SiO₂—Al₂O₃) glass frit, bismuth oxide-zinc oxide-boron oxide-silicon oxide (Bi₂O₃—ZnO—B₂O₃—SiO₂) glass frit, and bismuth oxide-zinc oxide-boron oxide-silicon oxide-aluminum oxide (Bi₂O₃—ZnO—B₂O₃—SiO₂—Al₂O₃) glass frit.

7. The composition as claimed in claim 1, wherein the black pigment includes a metal oxide containing at least one element selected from the group of Ru, Cr, Fe, Co, Mn, Cu, Ni.

8. The composition as claimed in claim 1, further comprising at least one of a sensitizer, a polymerization inhibitor, an antioxidant, an UV-absorber, an antifoaming agent, a dispersing agent, a leveling agent, and a plasticizer.

9. A plasma display panel comprising an electrode prepared from the composition as claimed in claim 1.

10. A method of fabricating a plasma display panel, the method comprising:
forming an electrode shape using a composition that includes:
a conductive material, the conductive material including Ni, Ag, and ITO,
an organic binder,
a glass frit, and
a black pigment; and
sintering the electrode shape to form an electrode.
